(19) United States
(12) Patent Application Publication
(10) Pub. No.: US 2025/0149278 A1
(43) Pub. Date: May 8, 2025

(54) ELECTRIC CIRCUIT BREAKER DEVICE

(71) Applicant: Daicel Corporation, Osaka (JP)

(72) Inventor: Yutaka SATO, Tokyo (JP)

(73) Assignee: Daicel Corporation, Osaka (JP)

(21) Appl. No.: 18/838,372

(22) PCT Filed: Sep. 26, 2022
(86) PCT No.: PCT/JP2022/035609

§ 371 Date: Aug. 14, 2024

(30) Foreign Application Priority Data
Feb. 15, 2022 (JP) 2022-021605

(51) Int. Cl. H01H 39/00

(52) U.S. Cl. CPC H01H 39/006; H01H 2039/008

(57) ABSTRACT

An electric circuit breaker device includes a housing including an accommodation space extending in one direction, an igniter, a projectile configured to be projected from an end side of the accommodation space, and a conductor piece forming part of an electric circuit, a region defined by an inner wall of the housing holding the conductor piece in the accommodation space serves as a holding region, and the projectile includes: a rod portion extending along the extending direction of the accommodation space and inserted into the holding region; and an elastic portion being a member having elasticity and provided on an outer periphery of the rod portion facing the inner wall of the holding region after the projectile is projected, and the elastic portion coming into contact with the inner wall of the holding region when the projectile is projected.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system in which the electric circuit is mounted, thereby urgently interrupting conduction of the electric circuit. As one aspect thereof, there has been proposed an electric circuit breaker device that forcibly and physically cuts a conductor piece forming a portion of an electric circuit by moving a projectile at high speed by energy applied from an igniter or the like (see, for example, Patent Document 1). Further, in recent years, electric circuit breaker devices applied to electric vehicles equipped with a high-voltage power source are becoming increasingly important.

### CITATION LIST

### Patent Literature

Patent Document 1: DE 212019000419 U1

Patent Document 2: U.S. Pat. No. 10,418,212 A

### SUMMARY OF INVENTION

### Technical Problem

In an electric circuit breaker device, a projectile projected at the time of actuation is stopped by abutting on a part of a housing after cutting a conductor piece and then the projectile is pushed back by the internal pressure of the gas of an igniter being lowered by the temperature drop. When the projectile is pushed back, the conductor piece evaporated by the arc discharge at the time of cutting may be diffused in the housing, and the insulation resistance value after cutting may be lowered. Therefore, it is desirable to stop the projectile from being pushed back after the conductor piece is cut.

The technique of the present disclosure has been made in view of the above-described circumstances, and an object thereof is to suppress the projectile from being pushed back after the conductor piece is cut.

### Solution to Problem

In order to solve the above problem, an electric circuit breaker device of the present disclosure includes:
a housing serving as an outer shell member and including an accommodation space extending in one direction;
an igniter provided in the housing;
a projectile disposed in the housing and configured to be projected from an end side of the accommodation space by energy received from the igniter and move along an extending direction of the accommodation space; and
a conductor piece held by the housing and forming a part of an electric circuit, the conductor piece including a cutoff portion disposed crossing the accommodation space between a first connection end portion as one connection end portion and a second connection end portion as the other connection end portion and configured to be cut off by movement of the projectile, wherein,
in the housing, a region defined by an inner wall of the housing holding the conductor piece in the accommodation space serves as a holding region, and
the projectile includes:
a rod portion extending along the extending direction of the accommodation space and inserted into the holding region; and
an elastic portion being a member having elasticity and provided on an outer periphery of the rod portion facing the inner wall of the holding region after the projectile is projected, and the elastic portion coming into contact with the inner wall of the holding region when the projectile is projected, and being compressed between the inner wall of the holding region and the rod portion.

In electric circuit breaker device,
in the first connection end portion of the conductor piece held by the housing, a boundary portion with the cutoff portion from which the cutoff portion is cut off may be defined as a first cutting edge portion,
in the second connection end portion, a boundary portion with the cutoff portion from which the cutoff portion is cut off may be defined as a second cutting edge portion, and
the elastic portion may be provided at a position where the elastic portion covers at least the first cutting edge portion and the second cutting edge portion after the projectile is projected.

In the electric circuit breaker device, the elastic portion may be a tubular member externally fitted to the rod portion.

In the electric circuit breaker device, the elastic portion may be fitted into a recess formed in an outer circumferential surface of the rod portion, and an outer end surface of the elastic portion may be provided protruding from the outer circumferential surface.

### Advantageous Effects of Invention

According to the present disclosure, the projectile can be prevented from being pushed back after the conductor piece is cut.

### BRIEF DESCRIPTION OF DRAWINGS

FIG. 1 is a view illustrating an internal structure of an electric circuit breaker device (hereinafter simply referred to as the “breaker device”) according to an embodiment.

FIG. 2 is a top view of a conductor piece according to the embodiment.

FIG. 3 is a vertical cross-sectional view (XY cross-sectional view) of the projectile.

FIG. 4 is a transverse cross-sectional view (XZ cross-sectional view) of the projectile taken along the line A-A in FIG. 3.

FIG. 5 is an enlarged view schematically illustrating a part of a portion where an elastic portion is provided.

FIG. 6 is a view illustrating actuation situations of the breaker device according to the embodiment.

FIG. 7 is a view schematically illustrating a testing device used in an electric circuit interruption test.

FIG. 8 is a vertical cross-sectional view (XY cross-sectional view) of a projectile according to a first modification.

FIG. 9 is a transverse cross-sectional view (XZ cross-sectional view) of the projectile taken along the line B-B in FIG. 8.

FIG. 10 is a vertical cross-sectional view (XY cross-sectional view) of a projectile according to second modification.

FIG. 11 is a transverse cross-sectional view (XZ cross-sectional view) of the projectile taken along the line C-C in FIG. 10.

### Description of Embodiments

### First Embodiment

An electric circuit breaker device according to an embodiment of the present disclosure will be described below with reference to the drawings. Note that each of configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

### Configuration

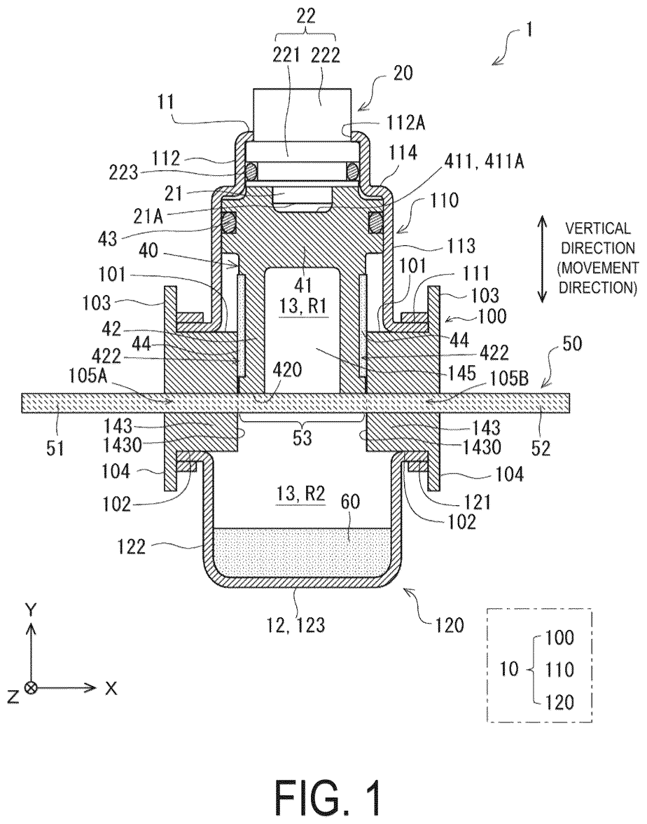

FIG. 1 is a view illustrating an internal structure of an electric circuit breaker device (hereinafter simply referred to as the “breaker device”) 1 according to an embodiment. The breaker device 1 is a device that interrupts an electric circuit included, for example, in a vehicle, an electric home appliance, a photovoltaic system, or the like when an abnormality occurs in the electric circuit or in a system including a battery (lithium ion battery, for example) of the electric circuit, thereby preventing great damage. In the present specification, a cross section in the height direction in FIG. 1 (direction in which an accommodation space 13 described later extends) is referred to as a vertical cross section of the breaker device 1, and a cross section in a direction orthogonal to the height direction is referred to as a transverse cross section of the breaker device 1. FIG. 1 illustrates a state prior to actuation of the breaker device 1.

The breaker device 1 includes a housing 10, an igniter 20, a projectile 40, a conductor piece 50, and a coolant material 60. The housing 10 serves as an outer shell member and encloses an accommodation space 13 extending in a direction from a first end portion 11 on an upper end side toward a second end portion 12 on a lower end side. This accommodation space 13 is a space formed linearly, making the projectile 40 movable, and extends along a vertical direction of the breaker device 1. As illustrated in FIG. 1, the projectile 40 is accommodated on the upper end side in the vertical direction (extending direction) of the accommodation space 13 formed inside the housing 10. In the present specification, the vertical direction is also referred to as a Y-axis direction, the left-right direction is also referred to as an X-axis direction, and the depth direction is also referred to as a Z-axis direction. However, in the present specification, the vertical direction and the XYZ directions of the breaker device 1 merely indicate a relative positional relationship of elements in the breaker device 1 for convenience of description of the embodiment. For example, the orientation at the time of installing the breaker device 1 is not limited to the direction illustrated in the drawing.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially prismatic outer shape. However, the shape of the housing body 100 is not particularly limited. In addition, the housing body 100 includes a cavity portion 145 formed therethrough along the vertical direction. This cavity portion 145 forms a portion of the accommodation space 13. Furthermore, the housing body 100 includes an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided erected upward from the upper surface 101 on the outer circumferential side of the upper surface 101 in the housing body 100. In the present embodiment, the upper tubular wall 103 has a rectangular tubular shape, for example, but may have any other shape. On the outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have any other shape. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped cylindrical tubular shape with a hollow inside. The top holder 110 includes a small diameter cylinder portion 112 positioned on the upper side (first end portion 11 side), a large diameter cylinder portion 113 positioned on the lower side, a connection portion 114 connecting these, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of a tubular space (a portion of the accommodation space 13) formed in the housing 10. Further, instead of the sealant or in combination with the sealant, an O-ring may be interposed between the upper surface 101 of the housing body 100 and the flange portion 111 of the top holder 110 to increase the airtightness of the tubular space.

The cavity portion formed inside the small diameter cylinder portion 112 in the top holder 110 functions as an accommodation space for accommodating a portion of the igniter 20 as illustrated in FIG. 1. Further, the cavity portion formed inside the large diameter cylinder portion 113 in the top holder 110 communicates with the cavity portion of the housing body 100 positioned below, and forms a portion of the tubular space. The top holder 110 configured as described above can be formed from an appropriate metal member, such as stainless steel or aluminum, having excellent strength and durability, for example. However, a material for forming the top holder 110 is not particularly limited. In addition, for the shape of the top holder 110 as well, the above aspect is an example, and other shapes may be adopted.

### Bottom Container

Next, the bottom container 120 will be described. The bottom container 120 has a substantially tubular bottomed shape with a hollow inside, and includes a side wall portion 122, a bottom wall portion 123 connected to a lower end of the side wall portion 122, and a flange portion 121 connected to an upper end of the side wall portion 122. The side wall portion 122 has, for example, a cylindrical tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of a tubular space (a portion of the accommodation space 13) formed in the housing 10. Further, instead of the sealant or in combination with the sealant, an O-ring may be interposed between the lower surface 102 of the housing body 100 and the flange portion 121 of the bottom container 120 to increase the airtightness of the tubular space.

Note that the above aspect regarding the shape of the bottom container 120 is an example, and other shapes may be adopted. Further, the cavity portion formed inside the bottom container 120 communicates with the housing body 100 positioned above, and forms a portion of the tubular space. The bottom container 120 configured as described above can be formed from an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed from an appropriate metal member, such as stainless steel or aluminum, having excellent strength and durability, and an interior portion facing the tubular space side may be formed from an insulating member such as a synthetic resin. Of course, the entire bottom container 120 may be formed from an insulating member.

As described above, the housing 10 in the embodiment includes the housing body 100, the top holder 110, and the bottom container 120 that are integrally assembled, and the tubular space extending in the direction from the first end portion 11 to the second end portion 12 is formed inside the housing 10. The tubular space accommodates the igniter 20, the projectile 40, a cutoff portion 53 in the conductor piece 50, the coolant material 60, and the like that will be described below in detail.

### Igniter

Next, the igniter 20 will be described. The igniter 20 is an electric igniter that includes an ignition portion 21 with an ignition charge, and an igniter body 22 including a pair of electro-conductive pins (not illustrated) connected to the ignition portion 21. The igniter body 22 is surrounded by an insulating resin, for example. Further, tip end sides of the pair of electro-conductive pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221. The igniter body 22 is fixed to the small diameter cylinder portion 112 by press-fitting, for example, the body portion 221 to an inner circumferential surface of the small diameter cylinder portion 112. Further, a constricted portion having an outer circumferential surface depressed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a cylindrical tubular shape covering sides of the electro-conductive pins, allowing connection with a connector of a power source.

As illustrated in FIG. 1, the ignition portion 21 of the igniter 20 is disposed facing the accommodation space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of electro-conductive pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the electro-conductive pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodation space 13. More specifically, the combustion gas from the igniter cup is discharged into a depressed portion 411 in a piston portion 41 described later of the projectile 40 disposed in the accommodation space 13. Thereby, the projectile 40 is projected downward from the initial position in FIG. 1 along the accommodation space 13.

### Conductor Piece

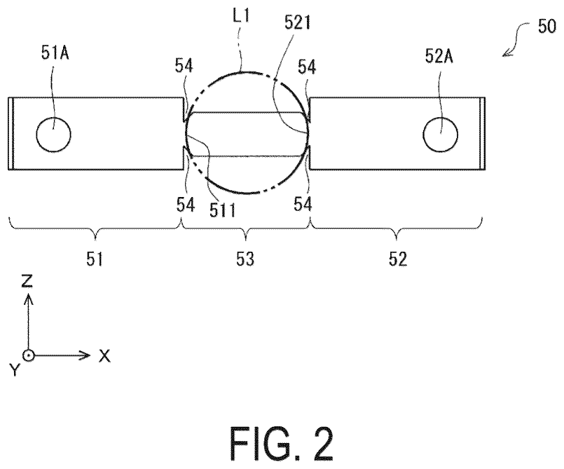

Next, the conductor piece 50 will be described. FIG. 2 is a top view of the conductor piece 50 according to the embodiment. The conductor piece 50 is a metal body having conductivity that constitutes a portion of the components of the breaker device 1 and, when the breaker device 1 is attached to a predetermined electric circuit, forms a portion of the electric circuit, and may be referred to as a bus bar. The conductor piece 50 is passed through a pair of conductor piece holding holes 51A and 52A in the housing body 100, and disposed across the cavity portion 145 in the housing body. In the present embodiment, a region (cavity portion 145) defined by an inner wall of the housing body 100 holding the conductor piece 50 in this way serves as a holding region.

The conductor piece 50 can be formed from a metal such as copper (Cu), for example. However, the conductor piece 50 may be formed from a metal other than copper, or may be formed from an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes a first connection end portion 51 and a second connection end portion 52 on both end sides, and the cutoff portion 53 positioned in an intermediate portion thereof. The first connection end portion 51 and the second connection end portion 52 of the conductor piece 50 are provided with connection holes 51A and 52A, respectively. These connection holes 51A, 52A are used to connect with other conductors (lead wires, for example) in the electric circuit. Note that in FIG. 1, the connection holes 51A and 52A in the conductor piece 50 are not illustrated. The cutoff portion 53 of the conductor piece 50 is a site that is forcibly and physically cut by the rod portion 42 of the projectile 40 and cut off from the first connection end portion 51 and the second connection end portion 52 when an abnormality such as an excessive current occurs in the electric circuit to which the breaker device 1 is applied.

Here, various forms of the conductor piece 50 can be adopted, and a shape thereof is not particularly limited. While, in the example illustrated in FIG. 2, surfaces of the first connection end portion 51, the second connection end portion 52, and the cutoff portion 53 form the same surface, the form is not limited thereto. For example, the conductor piece 50 may be connected in a posture where the cutoff portion 53 is orthogonal to or inclined to the first connection end portion 51 and the second connection end portion 52. Further, the planar shape of the cutoff portion 53 of the conductor piece 50 is not particularly limited, either. Of course, the shapes of the first connection end portion 51 and the second connection end portion 52 of the conductor piece 50 are not particularly limited, either.

In addition, the pair of conductor piece holding holes 105A and 105B are formed in the housing body 100 according to the embodiment. The pair of conductor piece holding holes 105A and 105B extend in a transverse cross-sectional direction orthogonal to the vertical direction (axis direction) of the housing body 100. More specifically, the pair of conductor piece holding holes 105A and 105B extend in a straight line with the cavity portion (accommodation space 13) of the housing body 100 interposed therebetween. The conductor piece 50 configured as described above is held in the housing body 100 in a state of being inserted through the pair of conductor piece holding holes 105A and 105B formed in the housing body 100. In the example illustrated in FIG. 1, the first connection end portion 51 of the conductor piece 50 is held in a state of being inserted through the conductor piece holding hole 105A, and the second connection end portion 52 is held in a state of being inserted through the conductor piece holding hole 105B. In this state, the cutoff portion 53 of the conductor piece 50 is positioned in the cavity portion (accommodation space 13) of the housing body 100.

As described above, the conductor piece 50 attached to the housing body 100 is held orthogonally to the extending direction (axis direction) of the accommodation space 13 with the cutoff portion 53 crossing the accommodation space 13. Note that reference sign L1 illustrated in FIG. 2 denotes an outer circumferential position of the rod portion 42 positioned above the conductor piece 50 in a state of being attached to the housing body 100 of the breaker device 1. The rod portion 42 includes a cutting-off surface 420 for cutting off the cutoff portion 53 during actuation of the igniter 20 on a tip end side, and an outer circumferential position LI of the rod portion 42 is also a contour of the cutoff surface 420. For this reason, in the conductor piece 50, a position overlapping the outer circumferential position L1 of the rod portion 42 is an expected cutting-off position. In the first connection end portion 51 of the conductor piece 50, a boundary portion with the cutoff portion 53 from which the cutoff portion 53 is cut off is defined as a first cutting edge portion 511, and in the second connection end portion 52, a boundary portion with the cutoff portion 53 from which the cutoff portion 53 is cut off is defined as a second cutting edge portion 521.

### Coolant Material

Next, the coolant material 60 disposed in the accommodation space 13 in the housing 10 will be described. Here, as illustrated in FIG. 1, before actuation of the breaker device 1 (the igniter 20), the cutoff portion 53 of the conductor piece 50 in a state of being held in the pair of conductor piece holding holes 51A and 52A in the housing body 100 is laterally bridged across the accommodation space 13 of the housing 10. Hereinafter, within the accommodation space 13 of the housing 10 separated by the cutoff portion 53 of the conductor piece 50, a region (space) in which the projectile 40 is disposed is referred to as a “projectile initial arrangement region R1”, and a region (space) positioned on the opposite side of the projectile 40 is referred to as an “arc-extinguishing region R2”. Note that as described above, since the gap is formed on the side of the cutoff portion 53 disposed across the accommodation space 13, the projectile initial arrangement region R1 and the arc-extinguishing region R2 are not completely isolated from each other by the cutoff portion 53, but communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodation space 13 is a region (space) for receiving the cutoff portion 53 cut off by the rod portion 42 of the projectile 40 projected during actuation of the breaker device 1 (igniter 20). In this arc-extinguishing region R2, the coolant material 60 as an arc-extinguishing material is disposed. The coolant material 60 is a coolant material for removing thermal energy of the arc generated and the cutoff portion 53 when the projectile 40 cuts off the cutoff portion 53 of the conductor piece 50, and cooling the arc and the cutoff portion 53, thereby suppressing arc generation during cutting off of a current or thereby extinguishing (eliminating) the generated arc.

The arc-extinguishing region R2 in the breaker device 1 is a space for receiving the cutoff portion 53 cut off from the first connection end portion 51 and the second connection end portion 52 of the conductor piece 50 by the projectile 40, and at the same time, has a significance as a space for effectively extinguishing an arc generated when the projectile 40 cuts off the cutoff portion 53. Then, in order to effectively extinguish the arc generated when the cutoff portion 53 is cut off from the conductor piece 50, the coolant material 60 is disposed as an arc-extinguishing material in the arc-extinguishing region R2.

As one aspect of the embodiment, the coolant material 60 is solid. As one aspect of the embodiment, the coolant material 60 is formed from a shape retaining body. The shape retaining body herein is, for example, a material that can keep a constant shape when no external force is applied and can hold the integrity (does not come apart), even if deformation can occur, when an external force is applied. For example, examples of the shape retaining body include a fibrous body formed into a desired shape. In the present embodiment, the coolant material 60 is formed from a metal fiber that is a shape retaining body. Here, examples of the metal fiber forming the coolant material 60 include an aspect in which at least any one of steel wool or copper wool is included. However, the above aspects in the coolant material 60 are examples, and the coolant material 60 is not limited to the above aspects.

The coolant material 60 is formed into a substantially disk shape, for example, and is disposed at a bottom portion of the bottom container 120.

### Projectile

Next, the projectile 40 will be described. The projectile 40 is formed from an insulating member such as a synthetic resin, for example, and includes the piston portion 41, the rod portion 42 connected to the piston portion 41, and an elastic portion 44 provided on the outer periphery of the rod portion 42. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The piston portion 41 has an outer diameter larger than the diameter of the cavity portion 145 in the housing body 100, and is configured to not enter the cavity portion 145 but to strike against a peripheral member forming the cavity portion 145, for example, the upper surface 101 of the housing body 100. That is, the piston portion 41 is formed with a transverse cross-sectional area orthogonal to the movement direction (axis direction) on the tip end side connected to the rod portion 42 being larger than the transverse cross-sectional area on the rear end side of the rod portion 42 and the transverse cross-sectional area of the cavity portion 145. The shape of the projectile 40 can be changed as appropriate according to the shape of the housing 10 and the like. For example, in the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

Further, the depressed portion 411 having a circular columnar shape, for example, is formed in an upper surface of the piston portion 41. This depressed portion 411 receives the ignition portion 21. A bottom surface of the depressed portion 411 is formed as a pressure receiving surface 411A that receives energy received from the igniter 20 during actuation of the igniter 20. Further, a constricted portion having an outer circumferential surface depressed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41 and extending along the extending direction of the accommodation space 13, for example, and is integrally connected to a lower end side of the piston portion 41. When the igniter 20 is actuated, the rod portion 42 moves along the extending direction of the accommodation space 13 and is inserted into the cavity portion 145 of the housing body 100. A lower end surface of the rod portion 42 is formed as a cutoff surface 420 for cutting off the cutoff portion 53 from the conductor piece 50 during actuation of the breaker device 1. Note that although the rod portion 42 in the present embodiment has a substantially cylindrical tubular shape, the shape thereof is not particularly limited, and can be changed in accordance with the shape and size of the cutoff portion 53 to be cut off from the conductor piece 50 during actuation of the breaker device 1. The rod portion 42 may have, for example, a columnar shape such as a circular column, an elliptical column, or a rectangular column, or a tubular shape such as an elliptical tube or a rectangular tube. Note that, in the initial position of the projectile 40 illustrated in FIG. 1, a region on a tip end side including the cutoff surface 420 in the rod portion 42 of the projectile 40 is disposed above the cavity portion (a holding region) 145 of the housing body 100.

The elastic portion 44 is formed of an insulating and elastic material such as rubber. The elastic portion 44 may be, for example, a member having a higher elastic limit or a lower elastic modulus than the rod portion 42.

In the projectile 40 configured as described above, the projectile 40 is projected from the initial position illustrated in FIG. 1 when the upper surface of the piston portion 41 including the pressure receiving surface 411A receives the energy stress from the igniter 20 during actuation of the igniter 20, and moves at high speed toward the second end portion 12 side (downward) along the accommodation space 13. Specifically, as illustrated in FIG. 1, the piston portion 41 of the projectile 40 is accommodated inside the large diameter cylinder portion 113 in the top holder 110, and is slidable in the axis direction along an inner wall surface of the large diameter cylinder portion 113. The projectile 40 after being projected is stopped when the lower end surface of the piston portion 41 comes into contact with (collides with) the upper surface 101 of the housing body 100. That is, the rod portion 42 up to the rear end thereof is fitted into the cavity portion 145.

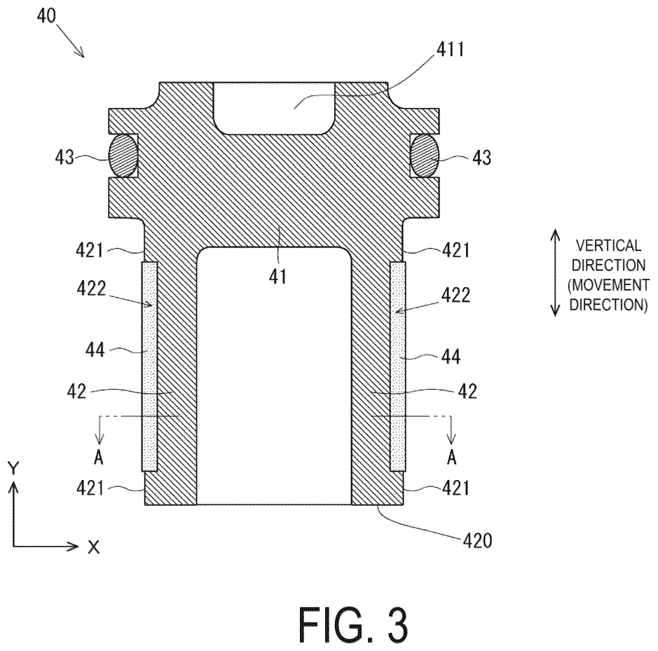

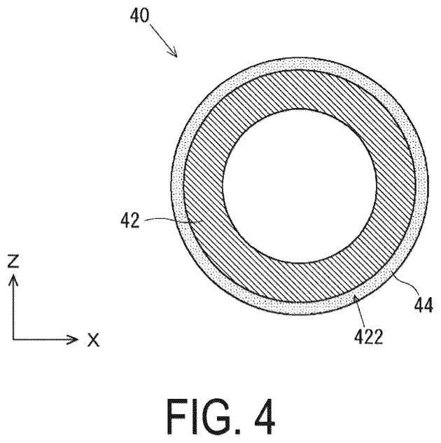

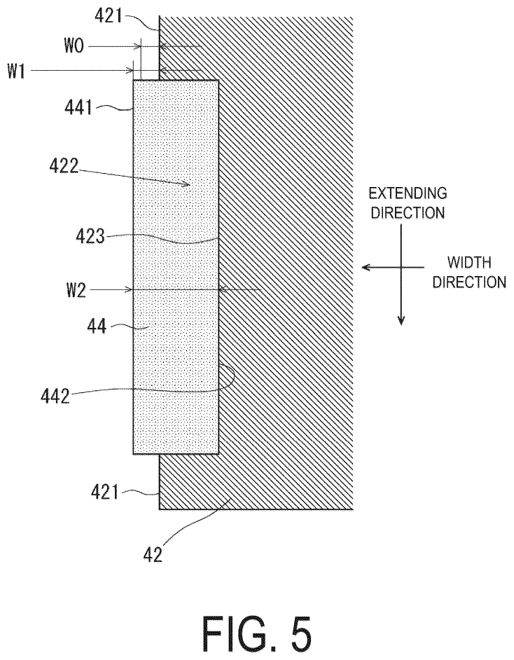

FIG. 3 is a vertical cross-sectional view (XY cross-sectional view) of the projectile 40, FIG. 4 is a transverse cross-sectional view (XZ cross-sectional view) of the projectile 40 taken along the line A-A in FIG. 3, and FIG. 5 is an enlarged schematic view of a part of a portion where the elastic portion 44 is provided. As illustrated in FIG. 3, in the rod portion 42 of the projectile 40, a recess 422 is provided on an outer circumferential surface 421 which faces the inner wall of the holding region after the projectile 40 is projected, and the tubular elastic portion 44 is externally fitted to the recess 422. Here, the elastic portion 44 is fitted into the recess 422 such that a part of the outer circumferential side protrudes from the outer circumferential surface 421 of the rod portion 42. That is, the elastic portion 44 is formed to have an outer diameter larger than that of the rod portion 42. The rod portion 42 of the projectile 40 is formed to have a diameter smaller than that of the cavity portion 145, and is configured to have a predetermined clearance W0 (FIG. 5) between the outer circumferential surface 421 of the rod portion 42 and an inner circumferential surface 1430 (FIG. 1) defining the cavity portion 145 when the rod portion 42 is inserted into the cavity portion 145. In contrast, the elastic portion 44 is formed such that a distance W1 between the outer circumferential surface 441 of the elastic portion 44 and the outer circumferential surface 421 of the rod portion 42 is longer than the clearance (gap) W0 of the rod portion 42 in the width direction WA orthogonal to the extending direction of the accommodation space 13. In addition, the elastic portion 44 is positioned in the width direction WA such that an inner circumferential surface 442 positioned on the opposite side to the outer circumferential surface 441 in the width direction WA is in contact with a recess circumferential surface 423 of the recess 422 of the rod portion 42. When the projectile 40 is projected and inserted into the cavity portion 145 together with the rod portion 42, the outer circumferential surface 441 of the elastic portion 44 comes into contact with the inner circumferential surface 1430 of the cavity portion 145, and the elastic portion 44 is compressed between the inner circumferential surface 1430 and the recess circumferential surface 423 of the rod portion 42.

### Operation

Next, operation content when the breaker device 1 is actuated to interrupt the electric circuit will be described. As described above, FIG. 1 illustrates a state of the breaker device 1 prior to actuation (hereinafter also referred to as the “pre-actuation initial state”). In this pre-actuation initial state, in the projectile 40 in the breaker device 1, the piston portion 41 is positioned on the first end portion 11 side (upper end side) in the accommodation space 13, and the cutoff surface 420 formed at the lower end of the rod portion 42 is set at an initial position positioned on the upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be cut off is connected, and a control unit (not illustrated) that controls the actuation of the igniter 20. In addition to the current flowing through the conductor piece 50, the abnormality detection sensor may be able to detect an abnormal state on the basis of a voltage or a temperature of the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the breaker device 1 is a computer capable of performing a predetermined function by executing a predetermined control program, for example. The predetermined function of the control unit may be realized by corresponding hardware. Then, when excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the electro-conductive pins of the igniter 20 and actuates the igniter 20 based on the current value detected by the abnormality detection sensor. Here, the abnormal current may be a current value that exceeds a predetermined threshold value set for protection of a predetermined electric circuit. Note that the abnormality detection sensor and the control unit described above need not be included in the components of the breaker device 1, and may be included in a device separate from the breaker device 1, for example. Further, the abnormality detection sensor and the control unit are not essential components of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from the external power source (not illustrated) to the electro-conductive pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodation space 13.

Here, the ignition portion 21 of the igniter 20 is received in the depressed portion 411 of the piston portion 41, and the rupture surface 21A of the ignition portion 21 is disposed facing the pressure receiving surface 411A of the depressed portion 411 in the projectile 40. Therefore, the combustion gas from the ignition portion 21 is discharged to the depressed portion 411, and the pressure (combustion energy) of the combustion gas is transmitted to the upper surface of the piston portion 41 including the pressure receiving surface 411A. As a result, the projectile 40 moves downward in the accommodation space 13 in the extending direction (axis direction) of the accommodation space 13.

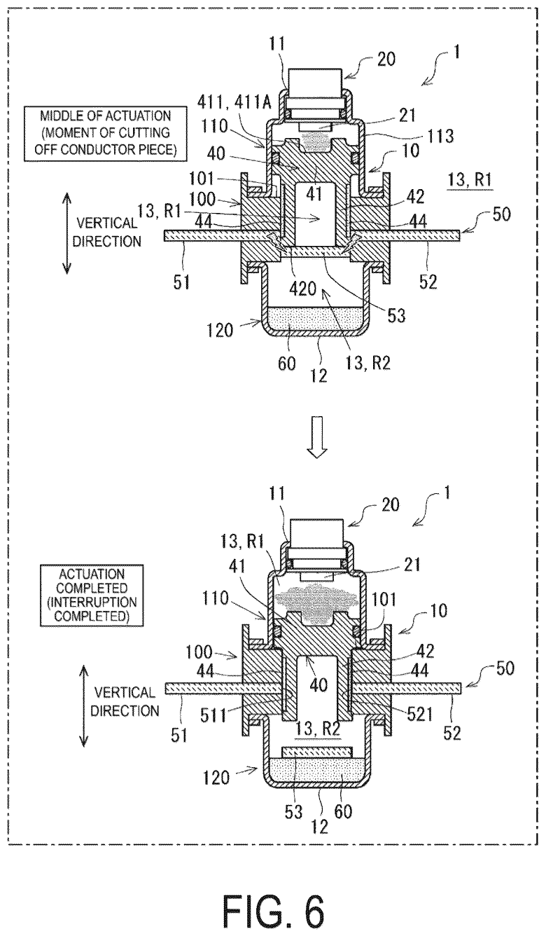

FIG. 6 is a view illustrating an actuation status of the breaker device 1 according to the embodiment. The upper part of FIG. 6 illustrates a status in the middle of actuation of the breaker device 1, and the lower part of FIG. 6 illustrates a status in which the actuation of the breaker device 1 is completed. As described above, by the actuation of the igniter 20, the projectile 40 having received the pressure (combustion energy) of the combustion gas of the ignition charge is pushed downward vigorously, and as a result, the cutoff surface 420 formed on the lower end side of the rod portion 42 pushes and cuts, by shearing, boundary portions between the cutoff portion 53 and each of the first connection end portion 51 and the second connection end portion 52 of the conductor piece 50. As a result, the cutoff portion 53 is cut off from the conductor piece 50. Note that as long as the projectile 40 can be moved smoothly in the extending direction (axis direction) of the accommodation space 13 when the igniter 20 is actuated, the shape and the dimensions of the projectile 40 can be freely determined, and the outer diameter of the piston portion 41 in the projectile 40 may be set to a dimension equal to the inner diameter of the large diameter cylinder portion 113 in the top holder 110, for example.

Then, as illustrated in the lower part of FIG. 6, the projectile 40 moves downward along the extending direction (axis direction) of the accommodation space 13 by a predetermined stroke until the lower end surface of the piston portion 41 comes into contact with (collides with) the upper surface 101 of the housing body 100. In this state, the cutoff portion 53, which has been cut off from the conductor piece 50 by the rod portion 42 of the projectile 40, is received in the arc-extinguishing region R2 where the coolant material 60 is disposed. As a result, the first connection end portion 51 and the second connection end portion 52 positioned at both ends of the conductor piece 50 are brought into an electrically disconnected state, and a predetermined electric circuit to which the breaker device 1 is applied is forcibly interrupted. Note that, when the cutoff portion 53 is cut off from the conductor piece 50 by the rod portion 42, an arc is likely to occur between the cutoff portion 53 having been cut off and the first and second connection end portions 51 and 52. However, even when an arc occurs, the coolant material 60 removes the thermal energy of the arc and the cutoff portion 53 to cool the arc and the cutoff portion 53, thereby quickly extinguishing the arc and suppressing influence of the arc. When the projectile 40 is further moved by the actuation of the igniter 20 to cut off the cutoff portion 53, the piston portion 41 pushes the gas on the projectile initial arrangement region R1 side to the arc-extinguishing region R2 side together with the particles of the conductor piece 50 transpired by the arc heat, as the piston portion 41 moves in the large diameter cylinder portion 113, thereby guiding the arc to the arc-extinguishing region R2 side to be extinguished by the coolant material 60 or the like.

Since the breaker device 1 of the present embodiment has the elastic portion 44 having a larger diameter than the rod portion 42 on the outer periphery of the rod portion 42, when the rod portion 42 is inserted into the cavity portion 145 by the operation of the breaker device 1 as described above and the lower end surface of the piston portion 41 comes into contact with the upper surface 101 of the housing body 100 and stops, the elastic portion 44 comes into contact with the inner circumferential surface 1430 of the cavity portion 145 and is compressed between the inner circumferential surface 1430 and the rod portion 42. Therefore, since the compressed elastic portion 44 is brought into pressure contact with the inner circumferential surface 1430 of the cavity portion 145 by the resilient force for returning to the original state, for example, even if the temperature of the gas generated by the operation of the igniter is lowered and the internal pressure is lowered, the projectile is stopped without being pushed back.

### Electric Circuit Interruption Test

Next, an electric circuit interruption test performed on the breaker device 1 will be described. In this blocking test, the elastic portion 44 is formed of silicone rubber manufactured by Tokawa Rubber Co., Ltd., and has a hardness of 48 points by a type A durometer in conformity with JISK6253 and a tensile strength of 7.9MPa. The elastic portion 44 has a 1 mm W2 (FIG. 5) from the outer circumferential surface 441 to the inner circumferential surface 442 in the direction orthogonal to the extending direction of the accommodation space 13.

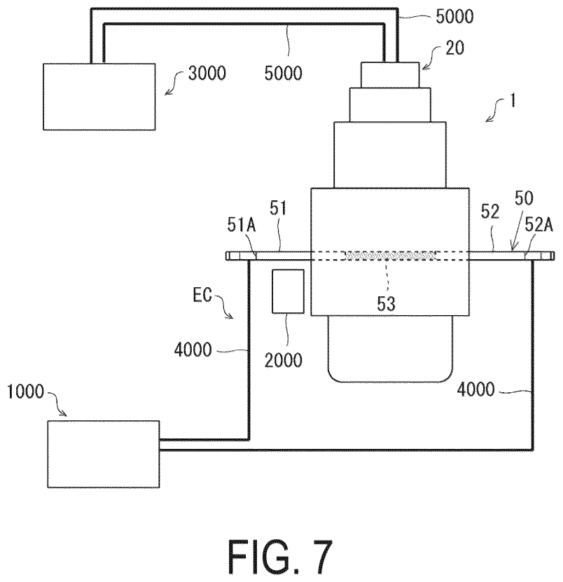

FIG. 7 is a view schematically illustrating a testing device used in an electric circuit interruption test. Reference sign 1000 denotes a power source, reference sign 2000 denotes an insulation resistance meter, and reference sign 3000 denotes an actuation power source. Further, reference sign 4000 denotes wiring for forming an electric circuit EC in cooperation with the conductor piece 50 of the breaker device 1. Further, reference sign 5000 denotes wiring for causing an actuation current supplied from the actuation power source 3000 to flow to the electro-conductive pins of the igniter 20 of the breaker device 1.

Next, the steps of the electric circuit interruption test will be described.

(Step 1) As illustrated in FIG. 7, the first connection end portion 51 and the second connection end portion 52 of the conductor piece 50 of the breaker device 1 are respectively connected to the power source 1000 by the wiring 4000, and the igniter 20 of the breaker device 1 is connected to the actuation power source 3000 by the wiring 5000.

(Step 2) The current from the power source 1000 is caused to flow to the electric circuit EC.

(Step 3) The actuation power source 3000 is turned on and the actuation current is applied to the igniter 20 of the breaker device 1, thereby actuating the igniter 20.

(Step 4) The power source 1000 and the actuation power source 3000 are turned off.

In the present interruption test, the test was performed according to the above steps, and an insulation resistance value between the first connection end portion 51 and the second connection end portion 52 when the cutoff portion 53 was cut off from the conductor piece 50 by the projectile 40 was measured by a commercially available insulation resistance meter 2000 (MY40 manufactured by Yokogawa Electric Corporation).

As a result of the test, it was confirmed that the insulation resistance value between the first connection end portion 51 and the second connection end portion 52 of the breaker device 1 was equal to or more than 2000 MΩ, and a good insulating property was obtained.

### EFFECTS OF EMBODIMENT

In the breaker device 1 according to the present embodiment, after the projectile 40 moves along the accommodation space 13 and cuts the conductor piece 50 due to the operation, the rod portion 42 of the projectile 40 is inserted into the accommodation space 13 (cavity portion 145), the elastic portion 44 is compressed between the rod portion 42 and the inner circumferential surface 1430 defining the accommodation space 13, and the elastic force of the elastic portion 44 acts as a holding force for the projectile 40. Thus, the breaker device 1 according to the present embodiment can prevent the projectile 40 from being pushed back toward the igniter side. As a result, in the breaker device 1 according to the present embodiment, the conductor piece 50 evaporated at the time of cutting the conductor piece 50 is prevented from being pushed back together with the projectile 40 and being diffused in the accommodation space, and a decrease in the insulation resistance value after cutting can be suppressed. Further, since the elastic portion 44 is provided at a position covering the first cutting edge portion 511 and the second cutting edge portion 521 after the projectile 40 is projected, the elastic portion 44 fills the gap between the outer circumferential surface 421 of the rod portion 42 and the inner circumferential surface 1430 defining the accommodation space 13, and the conductor piece 50 evaporated by the arc at the time of cutting can be suppressed from diffusing from the vicinity of the first cutting edge portion 511 and the second cutting edge portion 521. Therefore, a decrease in the insulation resistance value after the cutting can be suppressed.

The position where the elastic portion 44 is provided is not limited to the position covering the first cutting edge portion 511 and the second cutting edge portion 521, and the elastic portion 44 may be provided at another portion on the outer periphery of the rod portion 42, such as a position above the first cutting edge portion 511 and the second cutting edge portion 521 after the projectile 40 is projected, or a position below the first cutting edge portion 511 and the second cutting edge portion 521.

### First Modification

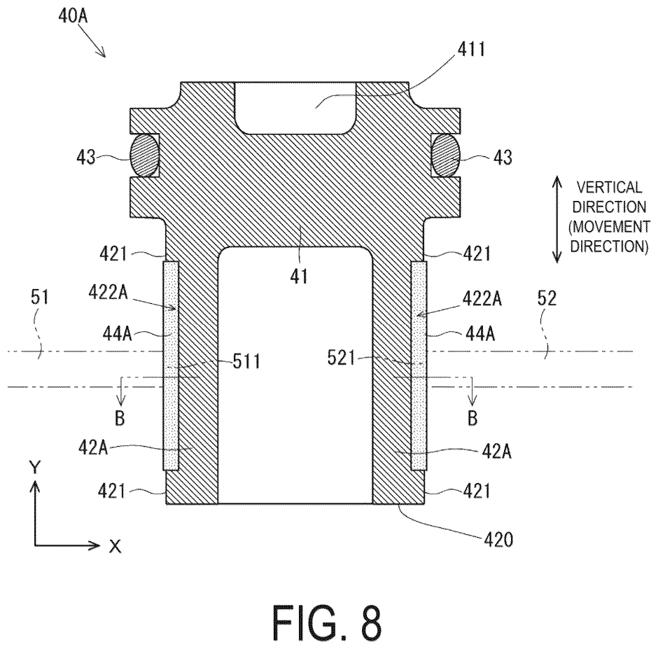

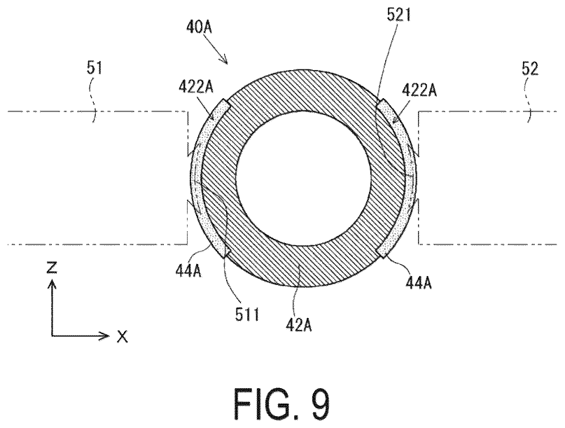

FIG. 8 is a vertical cross-sectional view (XY cross-sectional view) of a projectile 40A according to a first modification, and FIG. 9 is a transverse cross-sectional view (XZ cross-sectional view) of the projectile 40A taken along the line B-B in FIG. 8. In the projectile 40A of the present modification, an elastic portion 44A is not tubular, but is provided at a position covering the first cutting edge portion 511 and the second cutting edge portion 521 and at a part of a rod portion 42A in the circumferential direction. Note that since other portions are the same as those of the embodiment described above, the same elements are denoted by the same reference signs and description thereof will not be repeated.

As illustrated in FIG. 9, the rod portion 42A of the projectile 40A is provided with a recess 422A in a part in the circumferential direction, and the elastic portion 44A is fitted into the recess 422A. The elastic portion 44A is formed in an arc shape in a cross section (XZ cross section) orthogonal to the extending direction of the accommodation space 13. The configuration in which the outer peripheral portion of the elastic portion 44A protrudes from the outer circumferential surface 421 of the rod portion 42A and is compressed between the inner circumferential surface 1430 defining the accommodation space 13 and the rod portion 42A after the projectile is projected is the same as described above.

As described above, in the breaker device 1 of the present modification, the elastic portion 44A is provided on the outer periphery of the rod portion 42A, and when the rod portion 42A of the projectile 40A cuts the conductor piece 50 by the operation of the igniter 20 and is inserted into the cavity portion 145, similarly to the above-described embodiment, the elastic portion 44 is compressed between the inner circumferential surface 1430 defining the accommodation space 13 and the rod portion 42A, and the elastic force of the elastic portion 44A acts as a holding force of the projectile 40A, such that the projectile 40A can be prevented from being pushed back to the igniter side. Thus, the conductor piece 50 evaporated at the time of cutting is prevented from being pushed back together with the projectile 40A and diffused in the accommodation space, and the reduction of the insulation resistance value after cutting can be suppressed. Furthermore, since the elastic portion 44A is provided at a position covering the first cutting edge portion 511 and the second cutting edge portion 521 when the projectile 40A is projected, the elastic portion 44A fills the gap between the outer circumferential surface 421 of the rod portion 42A and the inner circumferential surface 1430 defining the accommodation space 13 at the time of actuation, and diffusion of the conductor piece 50 evaporated by the arc at the time of cutting can be suppressed. Therefore, a decrease in the insulation resistance value after the cutting can be suppressed.

### Second Modification

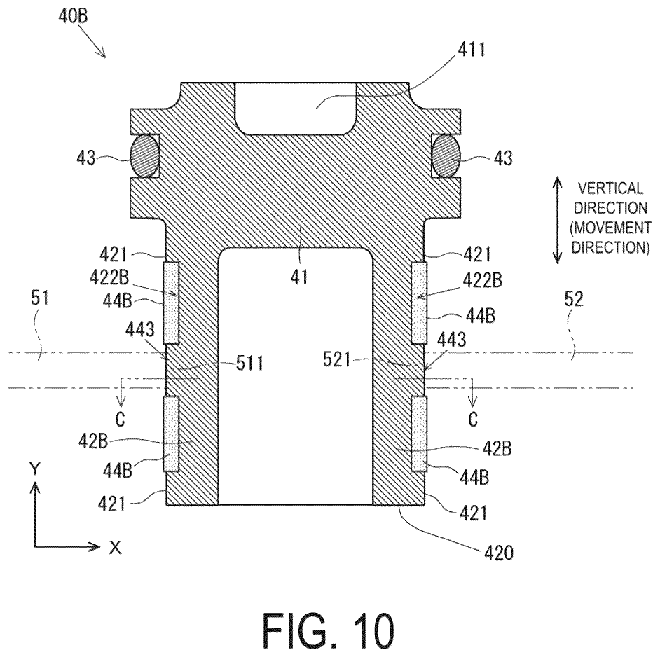

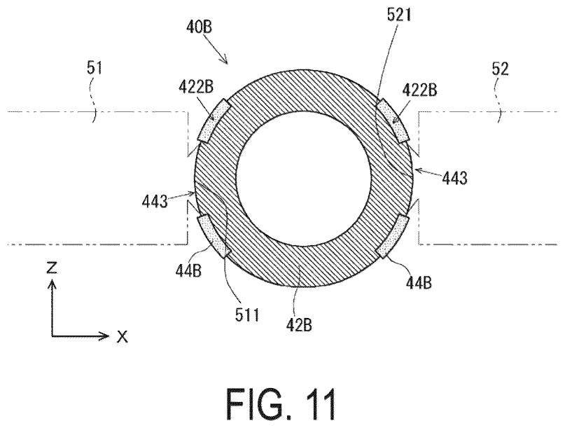

FIG. 10 is a vertical cross-sectional view (XY cross-sectional view) of a projectile 40B according to a second modification, and FIG. 11 is a transverse cross-sectional view (XZ cross-sectional view) of the projectile 40B taken along the line C-C in FIG. 10. In the projectile 40B of this modified example, an elastic portion 44B is provided at a position where the elastic portion does not come into contact with the first cutting edge portion 511 and the second cutting edge portion 521 and covers the periphery thereof. Since other configurations are the same as those of the above-described first modification, the same components are denoted by the same reference numerals, and the description thereof is omitted.

As illustrated in FIGS. 10 and 11, the rod portion 42B of the projectile 40B is provided with a recess 422B in a part in the circumferential direction, and the elastic portion 44B is fitted into the recess 422B. The elastic portion 44B has a gap 443 at a position where the first cutting edge portion 511 and the second cutting edge portion 521 are provided, and covers the first cutting edge portion 511 and the second cutting edge portion 521 via the gap 443 between the first cutting edge portion 511 and the second cutting edge portion 521.

As described above, since the breaker device 1 of the present modification includes the elastic portion 44B on the outer periphery of the rod portion 42B, it is possible to suppress the projectile 40B from being pushed back to the igniter side and to suppress a decrease in the insulation resistance value after the cutting, similarly to the above-described first modification. In the present modification, the elastic portion 44B is provided on a part of the outer periphery of the rod portion 42B as in Modification 1. However, the elastic portion may have a cylindrical tubular shape as in the above-described embodiment.

While the embodiment of the electric circuit breaker device according to the present disclosure has been described above, each of the aspects disclosed in the present specification can be combined with any other feature disclosed in the present specification.

### REFERENCE SIGNS LIST

1 Breaker device
10 Housing
100 Housing body
110 Top holder
111 Flange portion
120 Bottom container
121 Flange portion
122 Side wall portion
123 Bottom wall portion
13 Accommodation space
143 Inner wall
1430 Inner circumferential surface
145 Cavity portion
20 Igniter
40, 40A, 40B Projectile
41 Piston portion
42, 42A, 42B Rod portion
420 Cutoff surface
421 Outer circumferential surface
422, 422A, 422B Recess
44, 44A, 44B Elastic portion
50 Conductor piece
51 First connection end portion
511 First cutting edge portion
51A Conductor piece holding hole
52 Second connection end portion
521 Second cutting edge portion
53 Cutoff portion
60 Coolant material

1. An electric circuit breaker device comprising:
a housing serving as an outer shell member and including an accommodation space extending in one direction;
an igniter provided in the housing;
a projectile disposed in the housing and configured to be projected from an end side of the accommodation space by energy received from the igniter and move along an extending direction of the accommodation space; and
a conductor piece held by the housing and forming a part of an electric circuit, the conductor piece including a cutoff portion disposed crossing the accommodation space between a first connection end portion as one connection end portion and a second connection end portion as the other connection end portion and configured to be cut off by movement of the projectile, wherein,
in the housing, a region defined by an inner wall of the housing holding the conductor piece in the accommodation space serves as a holding region, and
the projectile includes
a rod portion extending along the extending direction of the accommodation space and inserted into the holding region, and
an elastic portion being a member having elasticity and provided on an outer periphery of the rod portion facing the inner wall of the holding region after the projectile is projected, the elastic portion coming into contact with the inner wall of the holding region when the projectile is projected, and being compressed between the inner wall of the holding region and the rod portion.

2. The electric circuit breaker device according to claim 1, wherein
in the first connection end portion of the conductor piece held by the housing, a boundary portion with the cutoff portion from which the cutoff portion is cut off is defined as a first cutting edge portion,
in the second connection end portion, a boundary portion with the cutoff portion from which the cutoff portion is cut off is defined as a second cutting edge portion, and
the elastic portion is provided at a position where the elastic portion covers at least the first cutting edge portion and the second cutting edge portion after the projectile is projected.

3. The electric circuit breaker device according to claim 2, wherein
the elastic portion is a tubular member externally fitted to the rod portion.

4. The electric circuit breaker device according to claim 1, wherein
the elastic portion is fitted into a recess formed in an outer circumferential surface of the rod portion, and an outer end surface of the elastic portion is provided protruding from the outer circumferential surface.

5. The electric circuit breaker device according to claim 2, wherein
the elastic portion is fitted into a recess formed in an outer circumferential surface of the rod portion, and an outer end surface of the elastic portion is provided protruding from the outer circumferential surface.

6. The electric circuit breaker device according to claim 3, wherein
the elastic portion is fitted into a recess formed in an outer circumferential surface of the rod portion, and an outer end surface of the elastic portion is provided protruding from the outer circumferential surface.
